(19) United States
(12) Patent Application Publication
(10) Pub. No.: US 2008/0250945 A1
(43) Pub. Date: Oct. 16, 2008

(54) FOOD PROCESSING APPARATUS AND OPERATING THEREOF

(75) Inventor: Richard David Seager, Norwich (GB)

Correspondence Address: BARNES & THORNBURG LLP, P.O. BOX 2786, CHICAGO, IL, 60690-2786, US

(73) Assignee: AEW DELFORD SYSTEMS LIMITED, Norwich (GB)

(21) Appl. No.: 12/100,938

(22) Filed: Apr. 10, 2008

(30) Foreign Application Priority Data
Apr. 13, 2007 (GB) 0707152.5

(51) Int. Cl. A47J 43/00; B26D 5/02; B26D 7/27; B26D 7/06; G05B 15/00

(52) U.S. Cl. 99/537; 83/74; 83/522.12; 83/155; 700/275

(57) ABSTRACT

Food processing apparatus is provided for use in the division of a food product such as cheese or meat in separate portions prior to packing of the portions into individual packs for sale. The apparatus comprises a machine for dividing the food products into portions, a control arrangement (22) for controlling the operation of the apparatus, and a sensing arrangement (28) for sensing at least one property of part of a food product (12) to be processed by the apparatus. The sensing arrangement outputs a signal to the control arrangement related to the sensed property of the food product. The control arrangement is operable to adjust an operating parameter of the apparatus with reference to said signal. In this way, the apparatus operates to improve control of its interaction with the food product, having regard to properties of a particular log of food product.

### FIELD OF THE INVENTION

The present invention relates to food processing apparatus for use in the division of a food product (such as cheese or meat) into separate portions prior to packaging of the portions into individual packs for sale.

### BACKGROUND OF THE INVENTION

Food processing companies which prepare food for sale by retailers are under pressure to increase throughput of products, whilst handling the food products as efficiently as possible. As the speed of the processing machines increases, their operation becomes more sensitive to variations in the properties of the products being handled.

Whilst some food products which are divided up into portions for sale are relatively homogeneous, particularly processed foods such as cheese or luncheon meat, products in their natural form such as bacon can vary from one log of product to the next, and also along the length of an individual log. Changes in the physical properties of the product can have a significant influence on the ability of a machine to divide the product and manipulate it.

In addition, a slicing machine will typically be set to cut slices of equal thickness or volume from a log of food product. Changes in the density of the food product will therefore lead to changes in the weight of the slices. In a system which seeks to cut groups of slices of a standard group weight, this can lead to divergence from the target, standard weight. If the group weights are too high, this effectively gives away excess food product, whilst if groups are under-weight, they are typically increased in weight by the addition of a further slice which is likely to result in an over-weight group, therefore increasing the amount of “give-away”.

### SUMMARY OF THE INVENTION

The present invention provides processing apparatus for use in the division of a food product into separate portions prior to packaging thereof, the apparatus comprising a machine for dividing the food product into portions; a control arrangement for controlling the operation of the apparatus; and a sensing arrangement for sensing at least one property of a part of a food product to be processed by the apparatus and for outputting a signal to the control arrangement related to the at least one property of the food product, wherein the control arrangement is operable to adjust an operating parameter of the apparatus with reference to said signal.

Apparatus in accordance with the invention is able to detect a property of a food product which is indicative of its condition. The controller can then adjust operation of the apparatus if appropriate having regard to the sensed property to take account of changes therein. In this way, the apparatus may seek to optimise its interaction with the food product, having regard to a physical or chemical property or properties of a particular log of food product.

The sensing arrangement may sense one property or two or more properties in combination. Where two or more properties are sensed, a signal may be generated by the sensing arrangement which is dependent on the combination of the properties. Alternatively, separate signals may be generated by the sensing arrangement, each relating to a respective property, for further processing by the controller.

The sensing arrangement may detect a property of a part of a food product, a property of the whole of a food product log, and/or the variation of a property along the length of a food product log.

In a preferred embodiment, an operating parameter of the apparatus other than a parameter governing portion size is adjustable with reference to said signal, wherein the operating parameter is adjusted so as to improve control of the physical interaction between the apparatus and the food product.

The characteristics of a food product tend to vary from one unit or log of product to the next. This may result from variations in the composition of the product or the time elapsed between the log being removed from a cold store and the start of the division process, for example. The characteristics of the log influence its interaction with the processing apparatus, such as how easily or smoothly it is divided or sliced (which may be termed the product's “sliceability”), and how flexible, malleable and/or heavy the food portions cut from the log are.

The properties of food portions affect their handling downstream of the dividing machine and therefore the control and consistency of the presentation of the food portions by the processing apparatus. For example, the physical properties of a slice cut from a log of food product will influence how the slice falls away from the slicing blade. This affects how the slice is positioned, orientated and presented downstream of the dividing machine.

Thus, in accordance with a preferred embodiment, each portion falls away from the food product onto a receiving surface when it is divided from the remainder by the dividing machine, and said operating parameter of the apparatus influences the transition of a portion from the food product to the receiving surface and therefore its location on the receiving surface.

The portions may be presented in vertical stacks, shingled stacks or arranged in groups. Increasingly, the procedure of packing the food portions presented by the processing apparatus is automated and involves robots. In order to maximise the reliability of the packing process, the food portions reaching the robots need to be consistently presented. This reduces the likelihood of interruption of a processing line to rectify any problems, which can be significantly detrimental to throughput.

In one embodiment, the dividing machine comprises a food slicing machine, and the controller is operable to adjust the rate at which slices are cut from a food product with reference to the signal from the sensing arrangement. Alternatively or in addition, the controller may be operable to adjust the slice thickness or slice volume cut from a food product with reference to the signal.

The dividing machine may include a rotatable cutting element, with the control arrangement operable to adjust the rate of rotation of the cutting element with reference to said signal. In further embodiments, a rotatable cutting element is mounted for orbital motion of its rotational axis relative to the machine, wherein the control arrangement is operable to adjust the rate of the orbital motion of the cutting element with reference to said signal.

The apparatus may include a jump conveyor for receiving slices cut from a food product by the dividing machine, and the control arrangement is operable to adjust the position and/or angle of the conveyor relative to the dividing machine with reference to said signal. These are further factors which may be adjusted to influence the transition of a portion from the food product to the receiving surface provided by the jump conveyor.

The property or properties detected by the sensing arrangement may be one or more selected from the following: temperature, density, product hardness, surface colour, salt content, water content and fat content.

The hardness of a food product may be sensed at its surface and/or internally. In some cases, hardness may vary with depth and so sensing inner or core product hardness will allow this to be taken into account. For example, greater fluid content may be present close to the product surface relative to a more central region, making the material near the surface softer.

The temperature of a product may be detected by an infra-red detector for example. Surface hardness may be measured by urging a probe into the surface of the product and determining how far the surface of the product is displaced by a given force. The conductivity of a food product may be measured to indicate its salt content. A measure of surface colour may be taken using a monochrome or colour camera, for example.

In a preferred embodiment, the processing apparatus includes an enclosure within which the processing of the food product by the dividing machine is carried out, and the sensing arrangement is provided within the enclosure, to minimise changes in the properties of the food product occurring between the sensing step and commencement of processing of the product. One or more properties may though be sensed outside the enclosure.

When the controller determines that adjustment of the operation of the processing apparatus is appropriate with reference to a sensed property of a food product waiting to be processed, an operator may be alerted to this, for example by an audible alarm. The operator may then be given the option to either allow or prevent the adjustment calculated by the control arrangement.

The present invention further provides a method of controlling processing apparatus to divide a food product into separate portions prior to packaging thereof, the apparatus including a machine for dividing the food product into portions, and a control arrangement for controlling its operation, wherein the method comprises the steps of sensing at least one property of a portion of a food product to be processed by the apparatus; outputting a signal to the control arrangement related to the at least one property of the food product; and adjusting the operation of the dividing machine with reference to said signal.

In a preferred embodiment, an operating parameter of the apparatus other than a parameter governing portion size is adjusted with reference to said signal, wherein the operating parameter is adjusted so as to improve control of the physical interaction between the apparatus and the food product.

In methods embodying the invention, the adjustment step may influence the fall of a portion divided from the food product to a receiving surface of the apparatus and therefore its location on the receiving surface.

### BRIEF DESCRIPTION OF THE DRAWINGS

Embodiments of the invention will now be described by way of example and with reference to the accompanying schematic drawings, wherein:

FIG. 1 shows a side view of the interior of a slicing machine, together with the machine's controller; and

FIG. 2 shows a side view of part of the interior of a slicing machine together with a jump conveyor.

### DETAILED DESCRIPTION

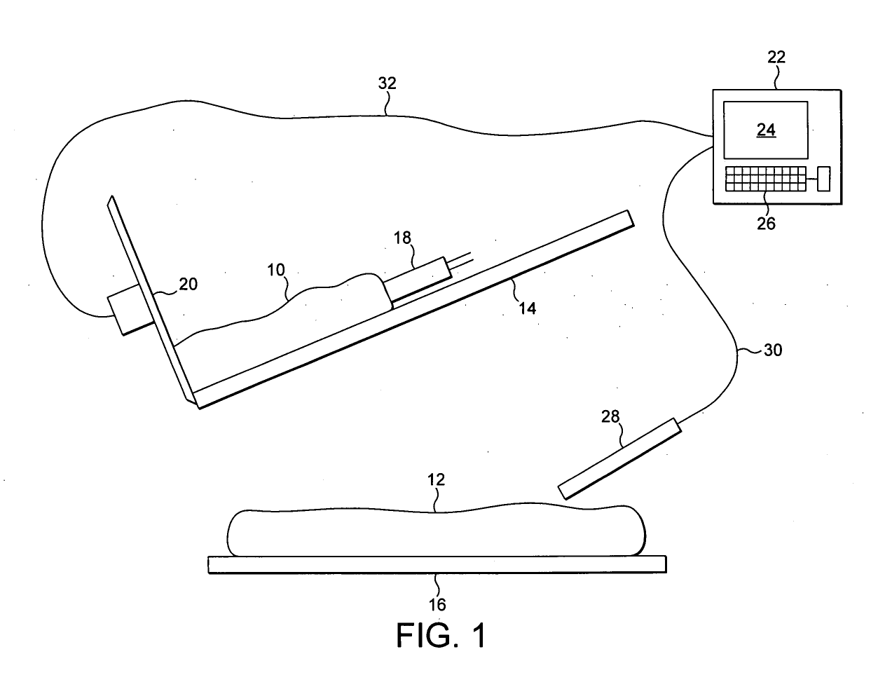

Two logs 10, 12 of a food product such as bacon are supported in the machine of FIG. 1 by respective beds 14 and 16. Log 10 rests on inclined bed 14 and is urged by a gripper 18 towards a rotary slicing blade 20.

Log 12 is the next log to be sliced and rests on bed 16 provided alongside bed 14. When slicing of log 10 has been completed, bed 16 is raised and inclined such that it lies in alignment with bed 14, to allow log 12 to be pushed onto bed 14 ready for slicing.

Operation of the slicing machine is controlled by a controller 22. This includes a display 24 and keyboard 26 to enable an operator to monitor and change the settings of the machine as appropriate.

A sensing means in the form of a probe is mounted in the slicing machine adjacent to the location of log 12. It is communicatively coupled to the controller via wire 30. Whilst log 10 is being sliced, log 12 is loaded onto bed 16 and a physical property thereof (such as its surface temperature) is measured by probe 28. The probe then outputs a signal to the controller along wire 30 representing a measured value associated with the sensed property. The controller is programmed to determine whether the measured value differs sufficiently with the value associated with the preceding log 10 to require adjustment of the operation of the slicing machine. The controller may be configured to carry out such an adjustment automatically prior to slicing of log 12. Alternatively, it may be programmed to alert an operator to the proposed adjustment which can then be accepted or denied by an operator via the keyboard 26.

For example, the controller may output a signal along wire 32 to a drive for the slicing blade which alters the rate at which slices are cut from log 12 relative to log 10.

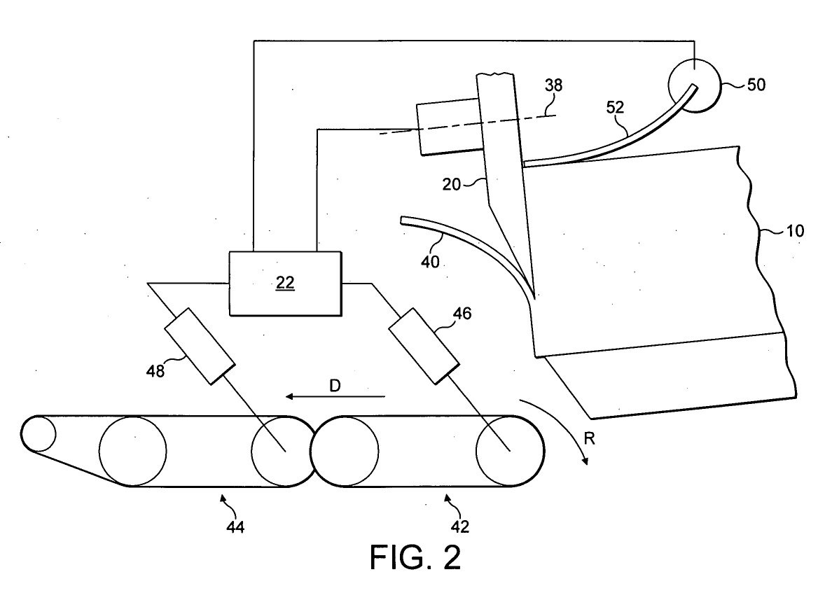

A partial side view of a slicing machine in combination with a jump conveyor is shown in FIG. 2. A configuration of this form is described in EP-A-0398603. The jump conveyor is formed by a first conveyor 42 in combination with a second, downstream conveyor 44. The conveyors 42 and 44 are driven by brushless DC motors 46 and 48 and are controlled independently by controller 22.

Slices 40 cut from the log 10 of food product by slicing blade 20 fall onto the upper surface of the first conveyor 42 of the jump conveyor. Groups of slices are carried away by the conveyor in direction D to be packed. Slicing blade 20 is rotatable about its rotational axis 30.

A sensor 50 is provided which has an arm 52 that engages the top of the log 10 immediately adjacent the blade 20. The sensor produces an output signal proportional to the height of the log 10. This output signal may be used to control the shingle speed so that the shingled pack has a substantially constant length in the shingled direction.

Close control of the manner in which slices 40 fall away from the log 10 during the cutting process is desirable to ensure accurate positioning of each slice on the first conveyor 42 and relative to other slices outputted on to the conveyor. This is dependent on the characteristics of the material forming log 10 and in accordance with an embodiment of the invention, a property of the food product is sensed which is related to the physical characteristics of a slice cut therefrom. This information may be used to address the manner in which each slice is cut from the log by rotating blade 20 and/or the positioning of the articulated jump conveyor 40, 42 with a view to achieving the desired presentation of the slices by the processing apparatus.

More particularly, the speed of rotation of the slicing blade 20 may be adjusted. In some configurations, the slicing blade may be mounted for orbital motion of its rotational axis relative to the slicing machine. This orbital motion may be in an opposite sense to the rotation of the blade about its axis. Controller 22 may adjust the rate of the orbital motion of the cutting blade with reference to a sensed property of the food log 10. Adjustment of the speed of rotation of the blade and/or the rate of its orbital motion varies the blade “slicing ratio”.

Where sensors of the processing apparatus determine that part of a food product is unsuitable for inclusion in the current packaging run, the controller may operate to cause rejection of selected portions cut from the log. Rejection may be achieved for example by reversing the direction of motion of first conveyor 42 so that a rejected slice or group of slices is directed away from the remainder of the line, along direction R marked in FIG. 2.

1. Processing apparatus for use in the division of a food product into separate portions prior to packaging thereof, the apparatus comprising:
a machine for dividing the food product into portions;
a control arrangement for controlling the operation of the apparatus; and
a sensing arrangement for sensing at least one property of a part of a food product to be processed by the apparatus and for outputting a signal to the control arrangement related to the at least one property of the food product, wherein the control arrangement is operable to adjust an operating parameter of the apparatus with reference to said signal.

2. Processing apparatus of claim 1, wherein an operating parameter of the apparatus other than a parameter governing portion size is adjustable with reference to said signal, wherein the operating parameter is adjusted so as to improve control of the physical interaction between the apparatus and the food product.

3. Processing apparatus of claim 1, wherein each portion falls away from the food product onto a receiving surface when it is divided from the remainder by the dividing machine, and said operating parameter of the apparatus influences the transition of a portion from the food product to the receiving surface and therefore its location on the receiving surface.

4. Processing apparatus of claim 1, wherein the control arrangement is operable to adjust the rate of cutting of a food product with reference to said signal.

5. Processing apparatus of claim 1, wherein the dividing machine includes a rotatable cutting element for cutting the food product into portions, and the control arrangement is operable to adjust the rate of rotation of the cutting element with reference to said signal.

6. Processing apparatus of claim 1, wherein the dividing machine includes a rotatable cutting element for cutting the food product into portions which is mounted for orbital motion of its rotational axis relative to the machine, wherein the control arrangement is operable to adjust the rate of the orbital motion of the cutting element with reference to said signal.

7. Processing apparatus of claim 1, wherein the apparatus includes a jump conveyor for receiving slices cut from a food product by the dividing machine, and the control arrangement is operable to adjust the position and/or angle of the conveyor relative to the dividing machine with reference to said signal.

8. Processing apparatus of claim 1, wherein the apparatus is operable to reject a portion of food product with reference to said signal.

9. Processing apparatus of claim 1, wherein the at least one property is one or more of the following: temperature, density, product hardness, surface colour, salt content, water content, and fat content.

10. Processing apparatus of claim 1, including an enclosure within which the processing of the food product is carried out, wherein the sensing arrangement are provided for sensing the at least one property of the food product within the enclosure.

11. Processing apparatus of claim 1, including an input device communicatively coupled to the control arrangement, so that when the control arrangement determines that adjustment of the operation of the processing apparatus with reference to said signal is required, an operator is alerted to this and able to allow or prevent the adjustment via the input device.

12. A method of controlling processing apparatus to divide a food product into separate portions prior to packaging thereof, the apparatus including a machine for dividing the food product into portions, and a control arrangement for controlling its operation, wherein the method comprises the steps of:
sensing at least one property of a part of a food product to be processed by the apparatus;
outputting a signal to the control arrangement related to the at least one property of the food product; and
adjusting the operation of the apparatus with reference to said signal.

13. A method of claim 12, wherein an operating parameter of the apparatus other than a parameter governing portion size is adjusted with reference to said signal, wherein the operating parameter is adjusted so as to improve control of the physical interaction between the apparatus and the food product.

14. A method of claim 12, wherein the adjustment step influences the fall of a portion divided from the food product to a receiving surface of the apparatus and therefore its location on the receiving surface.
